(19) United States
(12) Patent Application Publication
(10) Pub. No.: US 2025/0271864 A1
(43) Pub. Date: Aug. 28, 2025

(54) MOBILE OBJECT, CONTROL METHOD FOR MOBILE OBJECT, AND PROGRAM

(71) Applicant: Panasonic Intellectual Property Management Co., Ltd., Osaka (JP)

(72) Inventors: HIROYUKI SASAI, Osaka (JP); SHUNSUKE FUJITA, Osaka (JP)

(21) Appl. No.: 19/208,647

(22) Filed: May 15, 2025

Related U.S. Application Data
(63) Continuation of application No. PCT/JP2023/041044, filed on Nov. 15, 2023.

(30) Foreign Application Priority Data
Nov. 29, 2022 (JP) 2022-190502

(51) Int. Cl. G05D 1/622; G05D 1/222; G05D 1/246; G05D 107/17; G05D 109/10

(52) U.S. Cl. CPC G05D 1/622; G05D 1/222; G05D 1/246; G05D 2107/17; G05D 2109/10

(57) ABSTRACT

A mobile object is a mobile object that performs autonomous movement based on map information in which a first region where the mobile object is not permitted to stop except when entering and a second region where the mobile object is not permitted to stop except when entering the first region are set, and the mobile object includes a first determiner that performs a first determination as to whether or not to stop the autonomous movement; and a second determiner that performs a second determination as to whether or not to stop the autonomous movement based on a position where the mobile object is located when the first determiner performs the first determination.

### TECHNICAL FIELD

The present invention relates to a mobile object having a function of autonomously moving, a control method for a mobile object, and a program.

### BACKGROUND ART

A mobile object having both a function of autonomously moving and a function of moving according to a remote operation is known. As an example of such a mobile object, Patent Literature 1 discloses an autonomous flying drone used for spraying agricultural chemicals.

In the technique disclosed in Patent Literature 1, a user transmits an emergency operation command to a drone by using an emergency operation device to safely evacuate the drone. In addition, Patent Literature 1 discloses that a drone autonomously takes an evacuating action in a case where the drone detects that an emergency operation command cannot be transmitted due to a failure, a battery shortage, or the like of the emergency operation device. The evacuating action includes actions such as normal landing, hovering, normal return, and emergency return.

### CITATION LIST

### Patent Literature

PTL 1: Unexamined Japanese Patent Publication No. 2020-117221

### SUMMARY OF THE INVENTION

In a case where a mobile object traveling on the ground needs to stop, if the mobile object stops on the spot, the mobile object may undesirably obstruct passage of other persons and vehicles, thereby making it difficult to ensure safety.

In view of such circumstances, an object of the present disclosure is to provide a mobile object, a control method for a mobile object, and a program capable of ensuring safety at a time of stopping.

In order to achieve the above object, a mobile object according to one aspect of the present disclosure is a mobile object that autonomously moves based on map information in which a first region where the mobile object is not permitted to stop except when entering and a second region where the mobile object is not permitted to stop except when entering the first region are set, and includes a first determiner that performs a first determination as to whether or not to stop the autonomous movement; and a second determiner that performs a second determination as to whether or not to stop the autonomous movement based on a position where the mobile object is located when the first determiner performs the first determination.

A control method for a mobile object according to one aspect of the present disclosure is a control method for a mobile object performed by a computer included in a mobile object that is capable of autonomously moving, and includes performing a first determination as to whether or not to stop the autonomous movement in a case where the mobile object is autonomously moving based on map information in which a first region where the mobile object is not permitted to stop except when entering and a second region where the mobile object is not permitted to stop except when entering the first region are set; and performing a second determination as to whether or not to stop the autonomous movement based on a position where the mobile object is located when the first determination is performed.

A program according to one aspect of the present disclosure is a program executed by a computer included in a mobile object that is capable of autonomously moving, and causes the computer to perform a process including performing a first determination as to whether or not to stop the autonomous movement in a case where the mobile object is autonomously moving based on map information in which a first region where the mobile object is not permitted to stop except when entering and a second region where the mobile object is not permitted to stop except when entering the first region are set; and performing a second determination as to whether or not to stop the autonomous movement based on a position where the mobile object is located when the first determination is performed. According to the present disclosure, safety at a time of stopping can be ensured.

### BRIEF DESCRIPTION OF THE DRAWINGS

FIG. 1 is a diagram for explaining a mobile object system according to the present exemplary embodiment.

FIG. 2 is a diagram illustrating an example of a configuration of a remote operation device.

FIG. 3 is a diagram illustrating an example of a configuration of a mobile object.

FIG. 4 is a flowchart for explaining an autonomous movement operation of the mobile object system.

FIG. 5 is a diagram for explaining map information.

FIG. 6 is a flowchart for explaining a stop operation.

FIGS. 7A-7C are diagrams for explaining a first region and a second region.

FIGS. 8A-8D are diagrams for explaining a relationship between a current position of a mobile object, that is, a position where the mobile object is present when it is determined that autonomous movement is to be stopped, and a stop position.

FIG. 9 is a diagram for explaining a post-stop operation.

### DESCRIPTION OF EMBODIMENT

Hereinafter, an exemplary embodiment of the present disclosure will be described with reference to the drawings. Note that the same constituent elements are denoted by the same reference sign. Further, the drawings are schematically illustrated mainly for each constituent element for easy understanding.

### <Overall Configuration of Mobile Object System 100>

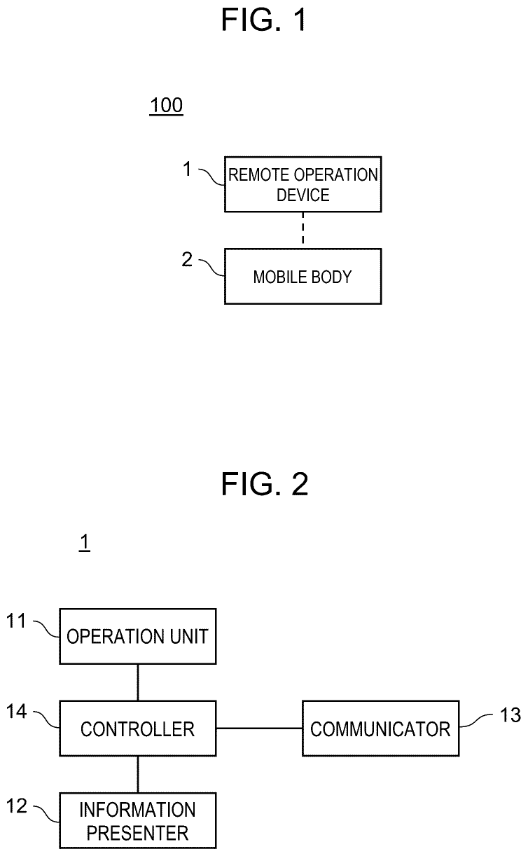

FIG. 1 is a diagram for explaining mobile object system 100 according to the present exemplary embodiment. As illustrated in FIG. 1, mobile object system 100 includes remote operation device 1 and mobile object 2. Remote operation device 1 and mobile object 2 can wirelessly communicate.

### [Remote Operation Device 1]

Remote operation device 1 is a device that receives an operation for controlling mobile object 2 from a supervisor who monitors mobile object 2 that autonomously moves. FIG. 2 is a diagram illustrating an example of a configuration of remote operation device 1. As illustrated in FIG. 2, remote operation device 1 includes operation unit 11, information presenter 12, communicator 13, and controller 14.

Operation unit 11 is an operation device for inputting contents of supervisor's control of mobile object 2. Operation unit 11 includes, for example, at least one of a keyboard, a mouse, a button, a switch, a foot pedal, a trackball, a touch pad, and the like, or a combination thereof.

Information presenter 12 is a notification device that displays information necessary for the supervisor to monitor mobile object 2, such as a situation around mobile object 2. The information necessary for the supervisor to monitor mobile object 2 includes, for example, various types of information such as an image of surroundings of mobile object 2 taken by a camera of mobile object 2, an image of a region including mobile object 2 taken by a camera installed in advance in a region where mobile object 2 moves, presence or absence of detection of an approaching object by a proximity sensor of mobile object 2, and an environmental sound of mobile object 2 recorded by a microphone of mobile object 2. Information presenter 12 includes at least one of a display such as a liquid crystal display or an organic EL display and an audio output device such as a speaker, an earphone, or a headphone.

Communicator 13 is a communication device that wirelessly communicates with mobile object 2. Note that although communicator 13 directly communicates with mobile object 2 in the example illustrated in FIG. 1, communicator 13 may communicate with mobile object 2 over a public network such as the Internet. In this case, another wireless communication device or the like can be included between remote operation device 1 and mobile object 2.

Controller 14 controls each unit of remote operation device 1. Controller 14 is, for example, a processor such as a central processing unit (CPU), and causes each unit of remote operation device 1 to perform various operations by reading a program from a memory (not illustrated) and executing the program. That is, remote operation device 1 is one kind of computer having controller 14 as a processor.

In mobile object system 100, the supervisor constantly monitors mobile object 2 that autonomously moves by information presenter 12, and performs an operation for controlling mobile object 2 on operation unit 11 as necessary. For example, in a case where the supervisor determines that mobile object 2 should not continue the autonomous movement, the supervisor performs an operation for giving a stop instruction to stop mobile object 2 by operation unit 11. Thereafter, the supervisor continues the monitoring of mobile object 2, and in a case where the supervisor determines that movement of mobile object 2 may be resumed, the supervisor performs an operation for giving a movement start instruction to resume the movement of stopped mobile object 2 by operation unit 11. Mobile object 2 that has resumed the movement in accordance with the movement start instruction may autonomously move again or may move in accordance with a remote operation of the supervisor.

### [Mobile Object 2]

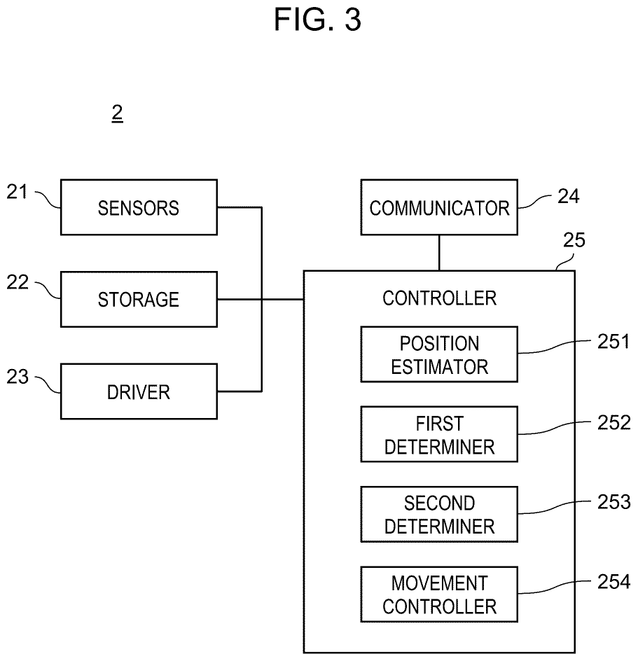

Mobile object 2 is a mobile object having both a function of autonomously moving and a function of moving based on a remote operation using remote operation device 1. FIG. 3 is a diagram illustrating an example of a configuration of mobile object 2. As illustrated in FIG. 3, mobile object 2 includes sensors 21, storage 22, driver 23, communicator 24, and controller 25.

Sensors 21 are sensors that acquire various types of information regarding a situation around mobile object 2 (hereinafter referred to as environmental information). Specifically, as sensors 21, a camera that takes an image of surroundings, a microphone that records surrounding environmental sound, a light detection and ranging (LiDAR) or a millimeter wave radar that measures a direction of an object around mobile object 2 and a distance to the object, a global navigation satellite system (GNSS) sensor such as a global positioning system (GPS) sensor for estimating a position of mobile object 2, a combination thereof, or the like can be adopted. That is, the environmental information includes an image of surroundings of mobile object 2, an environment sound of a place where mobile object 2 is present, a distance of mobile object 2 to an object, a direction in which the object is present, orbit information and time information from the GNSS satellite, and the like.

Storage 22 is a memory device that stores therein various types of information regarding mobile object 2. Specifically, storage 22 stores therein map information used for autonomous movement of mobile object 2. Details of the map information will be described later. Furthermore, storage 22 may store therein a program or the like executed by controller 25.

Driver 23 is a portion that moves mobile object 2 on the basis of control of movement controller 254, which will be described later. Driver 23 moves mobile object 2 by driving, for example, wheels, a crawler (caterpillar track), or a plurality of legs by using a motor or the like.

Communicator 24 is a communication device that wirelessly communicates with remote operation device 1. Among the environmental information generated by sensors 21, information regarding an image of surroundings, an environmental sound, and the like is transmitted to remote operation device 1 via communicator 24. The stop instruction, the movement start instruction, or the remote operation information for remotely operating mobile object 2 transmitted from remote operation device 1 is received via communicator 24 and input to controller 25.

Controller 25 controls each unit of mobile object 2. Controller 25 is, for example, a processor such as a CPU, and cause each unit of mobile object 2 to perform various operations by reading a program from storage 22 or the like and executing the program. That is, mobile object 2 is one kind of computer having controller 25 as a processor.

Controller 25 includes position estimator 251, first determiner 252, second determiner 253, and movement controller 254 as functional blocks.

Position estimator 251 performs processing of estimating a self-position, which is a position of mobile object 2, and generates self-position information. Position estimator 251 performs the self-position estimation processing on the basis of, for example, orbit information, time information, and the like acquired by sensors 21 from the GNSS satellite. Note that a method of estimating the self-position by position estimator 251 is not limited to a method using information acquired from the GNSS satellite, and a known technique may be appropriately adopted.

First determiner 252 performs first determination as to whether or not a first determination condition is satisfied. The first determination condition of first determiner 252 is set in advance, for example, by an administrator who manages operation of mobile object system 100.

An example of the first determination condition is at least one of reception of a stop instruction from remote operation device 1, disconnection of wireless communication between mobile object 2 and remote operation device 1, and necessity of safety confirmation of mobile object 2. Specific examples of the necessity of safety confirmation of mobile object 2 include the following. One example is that mobile object 2 enters a place requiring attention at a time of entry, such as a pedestrian crossing or a railroad crossing. Another example is that an obstacle such as an unattended bicycle or on-road parking is found on a moving route of mobile object 2. In a case where such a first determination condition is set, first determiner 252 determines that autonomous movement of mobile object 2 is to be stopped at least in one of a case where a stop instruction is received from remote operation device 1, a case where wireless communication between mobile object 2 and remote operation device 1 is disconnected, and a case where safety confirmation of mobile object 2 becomes necessary.

In a case where first determiner 252 determines that the first determination condition is satisfied, second determiner 253 performs second determination as to whether or not to stop the autonomous movement on the basis of the position of mobile object 2. That is, mobile object 2 stops the autonomous movement only in a case where first determiner 252 determines that the first determination condition is satisfied and second determiner 253 determines that the autonomous movement is to be stopped. In other words, in a case where first determiner 252 determines that the first determination condition is not satisfied, the autonomous movement of mobile object 2 is not stopped.

Details of the determination operations of first determiner 252 and second determiner 253 will be described later.

Movement controller 254 controls the movement of mobile object 2. When remote operation information is not received from remote operation device 1, movement controller 254 controls driver 23 so that mobile object 2 autonomously moves. More specifically, movement controller 254 sets a moving route of mobile object 2 on the basis of the environmental information acquired from sensors 21, the map information read from storage 22, and the self-position information acquired from position estimator 251, and controls driver 23 so that mobile object 2 moves along the movement route.

In a case where second determiner 253 determines in the second determination that the autonomous movement is to be stopped, movement controller 254 controls driver 23 to stop the autonomous movement.

In a case where a movement start instruction is received from remote operation device 1 via communicator 24 in a stopped state, movement controller 254 controls driver 23 to start movement as in a post-stop operation, which will be described later.

### Operation Example

An operation example of mobile object system 100 is described below.

### [Example of Autonomous Movement Operation]

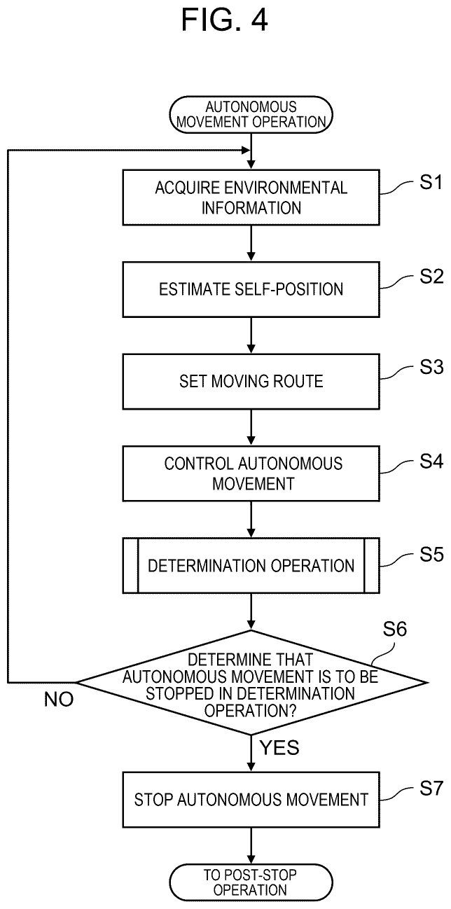

FIG. 4 is a flowchart for explaining an autonomous movement operation of mobile object system 100. The autonomous movement operation is an operation in which controller 25 of mobile object 2 causes mobile object 2 to perform autonomous movement. The autonomous movement operation may be started, for example, when the supervisor performs an operation for starting the autonomous movement on remote operation device 1.

In step S1, movement controller 254 of mobile object 2 acquires the environmental information from sensors 21.

In step S2, position estimator 251 estimates the self-position on the basis of the environmental information, and generates the self-position information.

In step S3, movement controller 254 newly sets or updates the moving route on the basis of the environmental information, the self-position information, and the map information read from storage 22.

FIG. 5 is a diagram for explaining the map information. FIG. 5 illustrates a part of map information in a region around a road including pedestrian crossing P. In the example illustrated in FIG. 5, sidewalk S is present at both ends of the road, and roadway R is present at a center of the road. In FIG. 5, a current position of mobile object 2 is CP.

In the map information, information regarding a position of waypoint W is installed in advance. Waypoint W is installed in a region where mobile object 2 can move. That is, waypoint W is a point that can be included in the moving route of mobile object 2. In other words, the moving route of mobile object 2 is set by connecting waypoints arranged in advance in the map information. In the example illustrated in FIG. 5, waypoint W is arranged on sidewalk S and pedestrian crossing P, and is not arranged within roadway R. That is, in the example illustrated in FIG. 5, a plurality of waypoints W are set within sidewalk S and pedestrian crossing P assuming that mobile object 2 cannot enter roadway R and can move in sidewalk S and pedestrian crossing P. In the present specification, an inside of the pedestrian crossing is not included in the roadway.

Although an example in which mobile object 2 moves on pedestrian crossing P and sidewalk S in the example illustrated in FIG. 5, a waypoint may be provided on a side strip or the like, for example, in a case where mobile object 2 moves on a road where no pedestrian crossing is provided.

As illustrated in FIG. 5, in a case where mobile object 2 at current position CP moves toward a destination, the moving route is set, for example, by connecting waypoints W so that a moving distance from current position CP to the destination is minimized. Note that a method of setting the moving route based on the waypoints is not limited to the method of connecting the waypoints so that the moving distance to the destination is minimized, and other methods may be appropriately adopted.

Note that the autonomous movement operation illustrated in FIG. 4 is repeatedly executed in a relatively short cycle from step S1 to step S5. In a case where the moving route is newly set in step S3, an old moving route may be appropriately updated to the newly set moving route. It is also possible to employ an arrangement in which a new movement route is not set (the operation in step S3 is not performed) after initial setting of the moving route is performed only once.

See FIG. 4 again. In step S4, movement controller 254 controls driver 23 so that mobile object 2 autonomously moves along the set moving route.

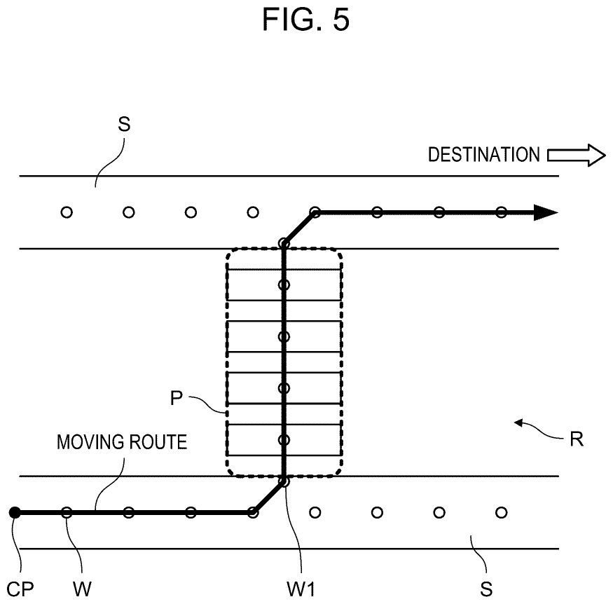

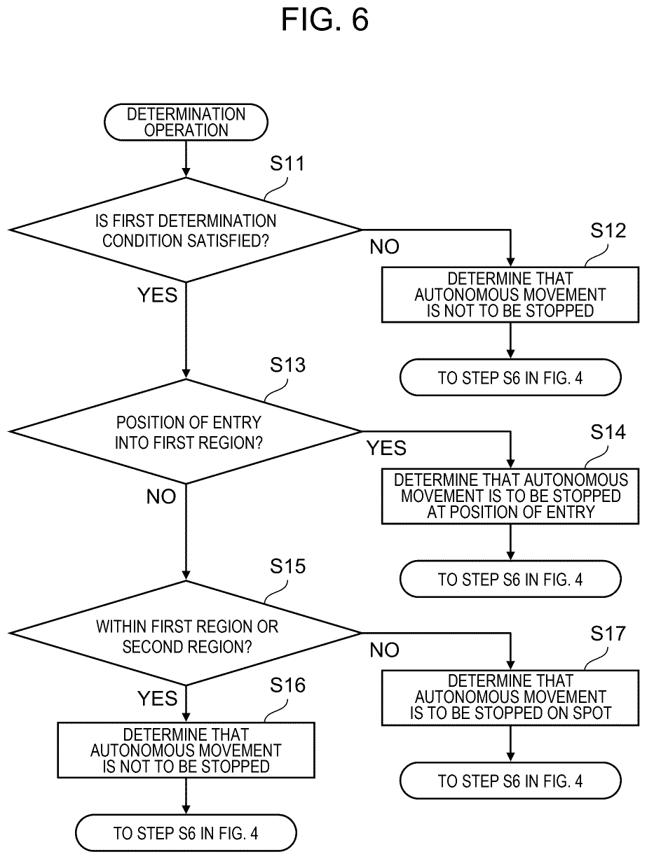

In step S5, while mobile object 2 is autonomously moving, first determiner 252 and second determiner 253 always perform a determination operation including the first determination and the second determination as to whether or not to stop the autonomous movement. Details of the determination operation will be described later with reference to FIG. 6.

In step S6, in a case where it is determined in the determination operation of step S5 that the autonomous movement is to be stopped (step S6: YES), movement controller 254 controls driver 23 to stop the autonomous movement of mobile object 2 in step S7. Otherwise (step S6: NO), the operation in step S1 is performed again.

Note that the processes in steps S1 to S6 excluding step S7 for shifting to the post-stop operation in the autonomous movement operation illustrated in FIG. 4 are repeatedly executed in a relatively short cycle as described above. By such an autonomous movement operation, mobile object 2 can safely perform autonomous movement while responding to a surrounding situation.

Note that, during the autonomous movement operation from step S1 to step S5, mobile object 2 constantly transmits, to remote operation device 1 via communicator 24, at least information regarding an image of surroundings and environmental sound among the environmental information generated by sensors 21 although this is not illustrated in FIG. 4. Remote operation device 1 displays the image of surroundings and reproduces the environmental sound acquired from mobile object 2 and thereby allows the supervisor to monitor mobile object 2, and receives a supervisor's operation. Although FIG. 4 illustrates an example in which the steps are sequentially performed, for example, the processes in step S1 to step S4 (processes for autonomous movement) may be performed in parallel.

### [Determination Operation]

Next, the determination operation in step S5 in FIG. 4 will be described in detail. FIG. 6 is a flowchart for explaining determination operations performed by first determiner 252 and second determiner 253.

In step S11, first determiner 252 determines whether or not the first determination condition described above is satisfied (first determination). This first determination is performed, for example, as follows.

As illustrated in FIG. 5, in a case where the moving route of mobile object 2 includes pedestrian crossing P, the first determination condition that safety confirmation of mobile object 2 is needed is satisfied when mobile object 2 reaches waypoint W1 immediately before entering pedestrian crossing P. Therefore, in this case, first determiner 252 determines that the first determination condition is satisfied.

In a case where a stop instruction is received from remote operation device 1 while mobile object 2 is moving along the moving route, the first determination condition that a stop instruction is received from remote operation device 1 is satisfied. Therefore, in this case, first determiner 252 determines that the first determination condition is satisfied when the stop instruction is received.

In a case where the wireless communication with remote operation device 1 is disconnected for some reason while mobile object 2 is moving along the moving route, the first determination condition that the wireless communication between mobile object 2 and remote operation device 1 is disconnected is satisfied. Therefore, in this case, first determiner 252 determines that the first determination condition is satisfied when the wireless communication is disconnected.

In a case where first determiner 252 determines in step S11 that the first determination condition is satisfied (step S11: YES), the operation proceeds to step S13, and otherwise (step S11: NO), the operation proceeds to step S12.

In a case where it is determined in the first determination that the first determination condition is not satisfied, first determiner 252 determines in step S12 that the autonomous movement is not to be stopped. Thereafter, the operation of controller 25 of mobile object 2 proceeds to step S6 in FIG. 4. In this case, since a result of the determination in step S6 is NO, the subsequent autonomous movement operation returns to step S1, and mobile object 2 continues the autonomous movement without stopping the autonomous movement.

On the other hand, in a case where it is determined in the first determination that the first determination condition is satisfied, second determiner 253 determines in step S13 whether or not the position of mobile object 2 at the time is a position of entry into a first region set in advance in the map information.

The first region is a region where mobile object 2 cannot stop except at a time of entry. In other words, the first region is a region where it is preferable from the viewpoint of safety that mobile object 2 needs to stop for safety confirmation at the time of entry and continues moving and quickly leaves after the entry. In a case where mobile object 2 stops inside the first region, it is expected that mobile object 2 hinders passage of other objects moving around mobile object 2, such as other vehicles and people or poses danger. Examples of the first region include an inside of a pedestrian crossing, an inside of a railroad crossing, and the like.

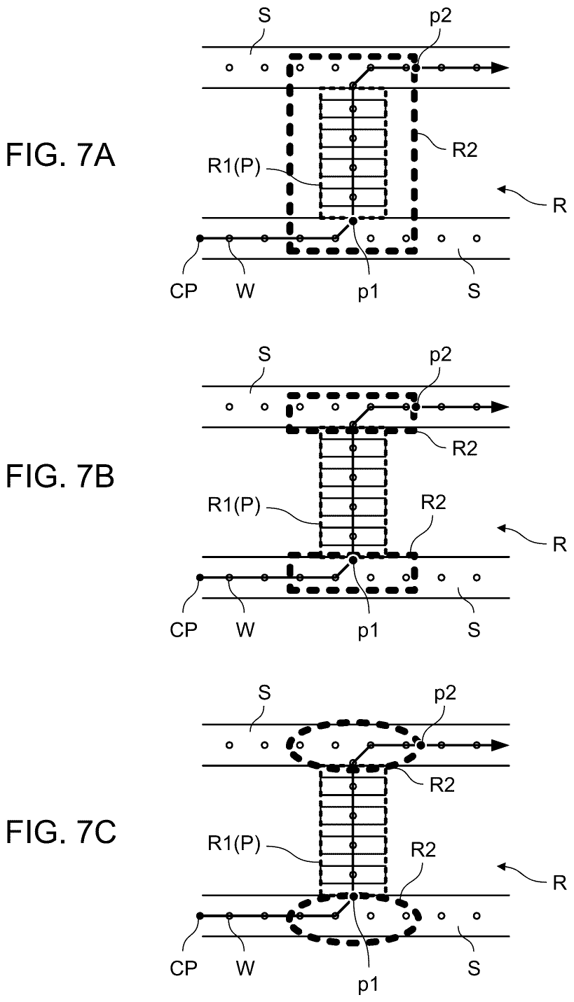

FIGS. 7A-7C illustrate an example of the first region set on a pedestrian crossing. In FIGS. 7A to 7C, first region R1 is set within a pedestrian crossing. Although only one first region is illustrated in the example illustrated in FIGS. 7A-7C, a plurality of first regions independent from each other may be provided.

The position of entry into the first region is a position where mobile object 2 transitions from an outside to an inside of the first region when moving along the moving route. That is, the position of entry into the first region is a position where the moving route of mobile object 2 intersects a boundary of the first region. In FIGS. 7A-7C, the position of entry into the first region is indicated by point p1.

Note that the position of entry into the first region may include not only the position where the moving route of mobile object 2 intersects a boundary of the first region, but also margins on the moving route before and after the position. That is, the position of entry into the first region may include a region on a slightly near side from the boundary of the first region (an outer side of the first region, an inner side of a second region, which will be described later) and a region on a slightly far side from the boundary of the first region (an inner side of the first region) in the moving path of mobile object 2. A size of the margins may be appropriately determined by, for example, an administrator or the like who manages the operation of mobile object system 100.

In a case where second determiner 253 determines in step S13 that the position of mobile object 2 is a position of entry into the first region (step S13: YES), the operation proceeds to step S14, and otherwise (step S13: NO), the operation proceeds to step S15.

In a case where it is determined in the second determination that the position of mobile object 2 is the position of entry into the first region, second determiner 253 determines in step S14 that the autonomous movement of mobile object 2 is stopped at the position of entry into the first region. Thereafter, the operation of controller 25 of mobile object 2 proceeds to step S6 in FIG. 4. In this case, since a result of the determination in step S6 is YES, the subsequent autonomous movement operation proceeds to step S7, and mobile object 2 stops the autonomous movement at the position of entry into the first region.

On the other hand, in a case where it is determined in the second determination that the position of mobile object 2 is not the position of entry into the first region, second determiner 253 further determines in step S15 whether or not the position of mobile object 2 is within the first region or the second region.

The second region is a region where mobile object 2 cannot stop except when entering the first region. In other words, the second region is a region where it is preferable from the viewpoint of safety to continue moving and quickly leave. As in the first region, in a case where mobile object 2 stops inside the second region, it is expected that mobile object 2 hinders passage of other objects moving around mobile object 2, such as other vehicles and people or poses danger. The second region is provided around the first region. More specifically, the second region is provided so as to surround the entire first region or at least a part of the first region. Examples of the second region include surroundings of a pedestrian crossing, surroundings of a railroad crossing, a braille block, a vicinity of an entrance of a house, a vicinity of an entrance of a store, and the like.

FIGS. 7A-7C illustrate an example of the second region set around a pedestrian crossing. In the example illustrated in FIG. 7A, second region R2 is set so as to surround pedestrian crossing P. In FIGS. 7B and 7C, second region R2 is set at two places so as to surround two regions where pedestrian crossing P and sidewalk S intersect with each other.

In a case where the moving route of mobile object 2 is set only on sidewalk S and pedestrian crossing P as illustrated in FIG. 5, if the first region and the second region are set as illustrated in FIGS. 7A-7C, mobile object 2 always passes through the second region before entering the first region. Furthermore, mobile object 2 always passes through the second region after leaving the first region. That is, waypoints for setting a moving route are provided in advance in the first region and the second region. In a case where the moving route of mobile object 2 passes through the first region, the moving route of mobile object 2 is set so as to always pass through the second region before and after the first region. In a case where a plurality of first regions is set, the moving route is set so as to always pass through the second region before and after each of the first regions.

Note that, in the example illustrated in FIG. 7A, second region R2 is set in a region including the entire pedestrian crossing and surroundings thereof, and therefore entire first region R1 overlaps second region R2. On the other hand, in the example illustrated in FIGS. 7B and 7C, first region R1 is set at a position connecting two second regions R2 including two regions where pedestrian crossing P and sidewalk S intersect, respectively. Therefore, in the example illustrated in FIGS. 7B and 7C, first region R1 is adjacent to second regions R2 or partially overlap second regions R2.

In the example illustrated in FIGS. 7A to 7C, the first region has a quadrangular shape. In the present disclosure, the shape of the first region is not limited to a quadrangle, and may be, for example, a circle, an ellipse, a polygon, or an indefinite shape. An example of the indefinite shape is such a shape that a plurality of quadrangular pedestrian crossings extend from one place at different angles. A start point and an end point are set in the first region, and the start point and the end point are always connected to the second region. In the example illustrated in FIGS. 7A to 7C, the start point of the first region is one end of pedestrian crossing P, and the end point of the first region is the other end of pedestrian crossing P. A plurality of start points and a plurality of end points may be provided in one first region, and it is only necessary that each of the plurality of start points and each of the plurality of end points be connected to the second region.

In the example illustrated in FIGS. 7A and 7B, second region R2 has a quadrangular shape. In the example illustrated in FIG. 7C, second region R2 has an elliptical shape. As described above, the shape of second region R2 can be set to an appropriate shape (for example, a polygonal shape) other than the quadrangular shape and the elliptical shape. For example, the second region provided after a certain first region and the second region provided before a next first region may overlap at least partially.

See FIG. 6 again. In step S15, in a case where second determiner 253 determines that the position of mobile object 2 is within the first region or the second region (step S15: YES), the operation proceeds to step S16. Otherwise (step S15: NO), the operation proceeds to step S17.

In a case where it is determined in the second determination that the position of mobile object 2 is within the first region or the second region, second determiner 253 determines in step S16 that the autonomous movement of mobile object 2 is not to be stopped. This determination is made for the following reason.

As described above, the first region and the second region are set as regions where mobile object 2 cannot stop except when entering the first region. However, since the determination condition is satisfied in the first determination of first determiner 252, it is necessary to promptly stop the autonomous movement. Therefore, mobile object 2 is configured to continue the autonomous movement along the moving route and stop the autonomous movement at a position where mobile object 2 reaches an outside of the first region and the second region. By such an operation, mobile object 2 can ensure safety by not stopping inside the first region and the second region and ensure safety by stopping promptly to a maximum extent. For this reason, in a case where the position of mobile object 2 is within the first region and the second region, second determiner 253 determines in step S16 to continue the autonomous movement until mobile object 2 reaches the outside of the first region and the second region.

In FIGS. 7A-7C, a position at which mobile object 2 reaches the outside of the first region and the second region is indicated by point p2. It is preferable that positions of the waypoints and the moving route are set in advance with consideration so that mobile object 2 stopped at the position where mobile object 2 reaches the outside of the first region and the second region does not hinder passage of other mobile bodies (including vehicles, people, and the like) around mobile object 2. Specifically, for example, the moving route of mobile object 2 is preferably set on an end of the sidewalk.

After step S16, the operation of controller 25 of mobile object 2 proceeds to step S6 in FIG. 4. In this case, since a result of the determination in step S6 is NO, the subsequent autonomous movement operation returns to step S1, and mobile object 2 continues the autonomous movement until mobile object 2 reaches the outside of the first region and the second region.

On the other hand, in a case where second determiner 253 determines that the position of mobile object 2 is not within the first region or the second region, second determiner 253 determines in step S17 that the autonomous movement of mobile object 2 is to be stopped on the spot.

After step S17, the operation of controller 25 of mobile object 2 proceeds to step S6 in FIG. 4. In this case, since a result of the determination in step S6 is YES, the subsequent autonomous movement operation proceeds to step S7, and mobile object 2 stops the autonomous movement on the spot.

In the flowchart illustrated in FIG. 6, the operations in step S13 to step S17 correspond to the second determination of second determiner 253. As described above, in the second determination, it is determined whether or not to stop the autonomous movement and where to stop the autonomous movement on the basis of the position of mobile object 2.

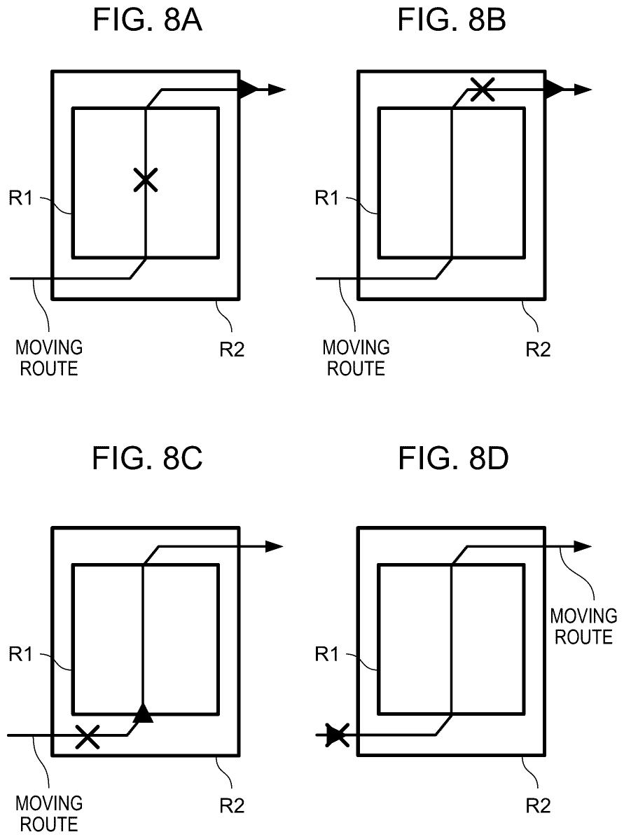

A specific example of operation during movement of mobile object 2 realized by the above description will be described with reference to FIGS. 8A-8D. FIGS. 8A-8D are diagram for explaining a relationship between a current position of mobile object 2, that is, a position where mobile object 2 is present when it is determined that the autonomous movement is to be stopped, and a stop position. In FIGS. 8A-8D, the x mark indicates the current position of mobile object 2, the black triangle indicates the stop position, and the arrow indicates the moving route of mobile object 2. FIGS. 8A-8D illustrate a case where first region R1 is inside second region R2 (corresponding to FIG. 7A).

FIG. 8A illustrates an example of a case where it is determined that the autonomous movement is to be stopped when mobile object 2 is within the first region. As shown in step S15 of FIG. 6, in this case, mobile object 2 continues to move along the moving route, and finally stops at a position where mobile object 2 reaches the outside of the first region and the second region.

The example of FIG. 8A corresponds, for example, to a case where wireless communication with remote operation device 1 is disconnected while mobile object 2 is crossing a pedestrian crossing. In this case, mobile object 2 stops at a position slightly away from the pedestrian crossing (a position where mobile object 2 reaches the outside of the second region) after crossing the pedestrian crossing (after reaching the outside of the first region), and therefore mobile object 2 can safely stop at a place where mobile object 2 does not hinder passage of other mobile bodies (including a person, a bicycle, and the like) crossing the pedestrian crossing and vehicles and the like traveling on the roadway.

FIG. 8B illustrates an example of a case where it is determined that the autonomous movement is to be stopped when mobile object 2 is located outside the first region and inside the second region. In this case, as shown in step S16 of FIG. 6, mobile object 2 continues to move along the moving route, and finally stops at a position where mobile object 2 reaches the outside of the first region and the second region, as in the case of FIG. 8A.

The example of FIG. 8B corresponds, for example, to a case where wireless communication with remote operation device 1 is disconnected immediately after mobile object 2 finishes crossing a pedestrian crossing. In this case, mobile object 2 stops at a position slightly away from a region where the pedestrian crossing and the sidewalk intersect (a position where mobile object 2 reaches the outside of the second region), and therefore mobile object 2 can safely stop at a place where mobile object 2 does not hinder passage of other mobile bodies (including a person, a bicycle, and the like) crossing the pedestrian crossing and vehicles and the like traveling on the roadway.

FIG. 8C illustrates an example of a case where it is determined that the autonomous movement is to be stopped when mobile object 2 is located outside the first region and inside the second region. The example of FIG. 8C is different from the example of FIG. 8B in that mobile object 2 has not entered the first region yet.

In this case, as shown in step S15 of FIG. 6, mobile object 2 continues to move along the moving route. However, unlike FIGS. 8A and 8B, the first region is present on the moving route, and therefore mobile object 2 stops at a position of entry into the first region (see step S14 in FIG. 6).

The example of FIG. 8C corresponds, for example, to a case where wireless communication with remote operation device 1 is disconnected when mobile object 2 is about to enter a pedestrian crossing. In this case, mobile object 2 stops immediately before crossing the pedestrian crossing (entering the first region), and therefore mobile object 2 can safely stop at a place where mobile object 2 does not hinder passage of other mobile bodies (including a person, a bicycle, and the like) crossing the pedestrian crossing and vehicles and the like traveling on the roadway.

FIG. 8D illustrates an example of a case where it is determined that the autonomous movement is to be stopped when mobile object 2 is located outside the first region and the second region. As described above, in this case, mobile object 2 stops on the spot.

The example of FIG. 8D corresponds, for example, to a case where wireless communication with remote operation device 1 is disconnected at a position where stopping hardly causes a problem, for example, a position on a sidewalk.

By such a determination operation, it is possible to stop the autonomous movement of mobile object 2 at a position where mobile object 2 hardly hinders movement of other mobile bodies (including a person and a vehicle) around mobile object 2 while ensuring safety of mobile object 2.

### [Post-Stop Operation]

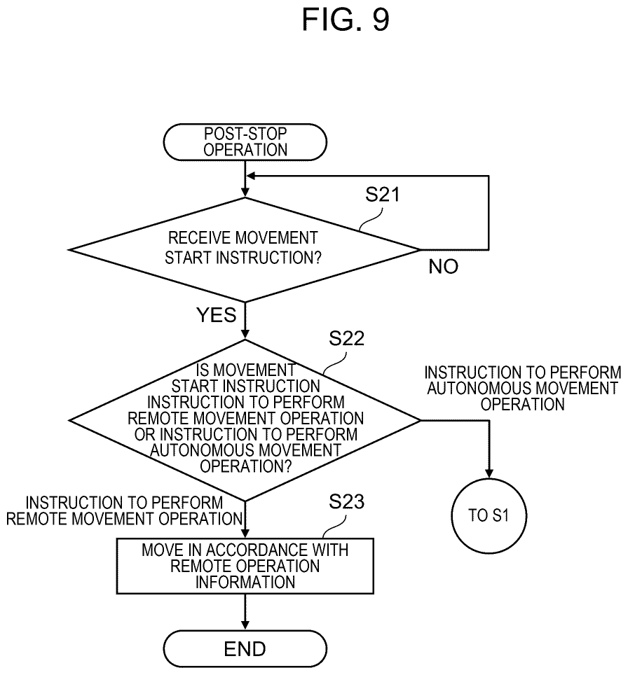

FIG. 9 is a diagram for explaining the post-stop operation.

In step S21, first determiner 252 determines whether or not a movement start instruction has been received from remote operation device 1. Here, the movement start instruction includes at least either an instruction to perform a remote movement operation using remote operation device 1 or an instruction to perform an autonomous movement operation. In a case where it is determined in step S21 that a movement start instruction has been received from remote operation device 1 (step S21: YES), the operation proceeds to step S22, and otherwise (step S21: NO), step S21 is repeated.

In step S22, first determiner 252 determines whether the movement start instruction received from remote operation device 1 is an instruction to perform a remote movement operation or an instruction to perform an autonomous movement operation.

In a case where it is determined in step S22 that the instruction to perform a remote movement operation has been received (step S22: instruction to perform remote movement operation), the operation proceeds to step S23. In a case where it is determined that the received movement start instruction is an instruction to perform an autonomous movement operation (step S22: instruction to perform autonomous movement operation), the operation returns to step S1 of FIG. 4, that is, the autonomous movement operation.

In step S23, movement controller 254 controls driver 23 to move mobile object 2 on the basis of remote operation information from remote operation device 1. The remote operation information is information for remotely operating mobile object 2 given by the supervisor, and includes information such as a moving direction and a moving speed during remote operation of mobile object 2. As a result, mobile object 2 can be moved by the supervisor's remote operation.

According to such a post-stop operation, mobile object 2 resumes the movement only when receiving a movement start instruction given by the supervisor after stopping the autonomous movement in the autonomous movement operation illustrated in FIG. 4. Since the supervisor resumes the movement of mobile object 2 only when the supervisor confirms safety while referring to a situation around mobile object 2, it is possible to ensure safety of mobile object 2 and surroundings.

In addition, the supervisor can select whether to resume the autonomous movement of mobile object 2 or to move mobile object 2 by remote control as necessary. Accordingly, remote operation is performed in a scene that is difficult to cope with by autonomous movement, for example, in a case of detouring around an obstacle, and mobile object 2 is caused to autonomously move in other scenes, and therefore it is possible to minimize a supervisor's burden of remote operation. Note that mobile object 2 may be configured to be able to return to the autonomous movement at any time in response to a supervisor's operation even when mobile object 2 is moving in accordance with supervisor's remote operation.

### <Modification>

In the exemplary embodiment described above, at least one of reception of a stop instruction from remote operation device 1, disconnection of wireless communication between mobile object 2 and remote operation device 1, and necessity of safety confirmation of mobile object 2 has been exemplified as the first determination condition of the first determination performed by first determiner 252. However, the first determination condition described in the exemplary embodiment is an example, and various first determination conditions other than the above example can be set in the present disclosure.

As an example, an audio analyzer that analyzes environmental sound acquired by the sensors may be further included, and the determiner may determine that the autonomous movement is to be stopped when the audio analyzer detects a predetermined sound, for example, approach of an emergency vehicle such as an ambulance or a fire engine. The audio analyzer may calculate an approximate distance between the mobile object and the emergency vehicle on the basis of the environmental sound acquired by the sensors, and the determiner may determine that the mobile object is to be stopped in a case where the distance is smaller than a threshold value.

### INDUSTRIAL APPLICABILITY

The present disclosure is useful for a mobile object system including a mobile object that performs autonomous movement.

### REFERENCE MARKS IN THE DRAWINGS

100 mobile object system
1 remote operation device
11 operation unit
12 information presenter
13 communicator
14 controller
2 mobile object
21 sensors
22 storage
23 driver
24 communicator
25 controller
251 position estimator
252 first determiner
253 second determiner
254 movement controller

1. A mobile object that autonomously moves based on map information in which a first region where the mobile object is not permitted to stop except when entering and a second region where the mobile object is not permitted to stop except when entering the first region are set, the mobile object comprising:
a first determiner that performs a first determination as to whether or not to stop the autonomous movement; and
a second determiner that performs a second determination as to whether or not to stop the autonomous movement based on a position where the mobile object is located when the first determiner performs the first determination.

2. The mobile object according to claim 1, wherein
in a case where it is determined in the first determination that the autonomous movement is to be stopped, the second determiner determines in the second determination that the autonomous movement is to be stopped at a position of entry into the first region in a case where the mobile object is at the position of entry into the first region.

3. The mobile object according to claim 1, wherein
in a case where it is determined in the first determination that the autonomous movement is to be stopped, the second determiner determines in the second determination that the autonomous movement is not to be stopped in a case where the mobile object is not at a position of entry into the first region and is located within the first region or the second region.

4. The mobile object according to claim 1, wherein
in a case where it is determined in the first determination that the autonomous movement is to be stopped, the second determiner determines in the second determination that the mobile object is to be stopped in a case where the mobile object is not located within the first region nor the second region.

5. The mobile object according to claim 1, wherein
the first region partially or entirely overlaps the second region or is adjacent to the movement in a case where the mobile object is autonomously moving based on map information in which a first region where the mobile object is not permitted to stop except when entering and a second region where the mobile object is not permitted to stop except when entering the first region are set; and
performing a second determination as to whether or not to stop the autonomous movement based on a position where the mobile object is located when the first determination is performed.
second region, and
a moving route of the mobile object during the autonomous movement is set to pass through the second region before and after passing through the first region.

6. The mobile object according to claim 1, wherein
the first determiner determines in the first determination that the autonomous movement is to be stopped when receiving a stop instruction from a remote operation device that remotely operates the mobile object.

7. The mobile object according to claim 1, wherein
the first determiner determines in the first determination that the autonomous movement is to be stopped in a case where the mobile object is at a position of entry into the first region.

8. The mobile object according to claim 1, wherein
the first determiner performs the first determination based on an environmental sound around the mobile object.

9. A control method for a mobile object performed by a computer included in a mobile object that is capable of autonomously moving, the control method comprising:
performing a first determination as to whether or not to stop the autonomous movement in a case where the mobile object is autonomously moving based on map information in which a first region where the mobile object is not permitted to stop except when entering and a second region where the mobile object is not permitted to stop except when entering the first region are set; and
performing a second determination as to whether or not to stop the autonomous movement based on a position where the mobile object is located when the first determination is performed.

10. A program executed by a computer included in a mobile object that is capable of autonomously moving, the program causing the computer to perform a process comprising:
performing a first determination as to whether or not to stop the autonomous
